(19) United States
(12) Patent Application Publication
(10) Pub. No.: US 2006/0277287 A1
(43) Pub. Date: Dec. 7, 2006

(54) Maintenance and administration user interface

(75) Inventors: Keith A. McCall, Sammamish, WA (US); Ronald S. Woan, Redmond, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: Azaleos Corporation

(21) Appl. No.: 11/285,482

(22) Filed: Nov. 21, 2005

Related U.S. Application Data
(60) Provisional application No. 60/688,528, filed on Jun. 7, 2005.

(51) Int. Cl. G06F 15/173

(52) U.S. Cl. 709/223

(57) ABSTRACT

Methods and apparatuses for facilitating a user in maintaining and administering one or more processes of an executing system image through a user interface having a plurality of views, are described herein.

### CROSS-REFERENCES TO RELATED APPLICATIONS

This application claims the benefit of U.S. Provisional Application No. 60/688, 528, filed on Jun. 7, 2005, entitled ROLES-BASED, WORKFLOW-ENABLED WEB BASED ADMINISTRATION CONSOLE, the specification and drawings of which are incorporated herein in full by reference.

### TECHNICAL FIELD

Embodiments of the present invention relate to the field of data processing, in particular, to facilitating users in maintaining and administering one or more processes of an executing system image through a user interface, the user interface having a plurality of views.

### BACKGROUND

Continuous advancements in the speed of processors, system memory, and storage have allowed software developers to create programs of increasing complexity and usefulness for a broad range of user services. Advancements in display technology have also provided developers with the opportunity to present their applications to users through increasingly friendlier user interfaces, interfaces that allow users not only to perform the functions of the application, but also to do such things as administering the application. These advancements, along with concurrent advancements in networking technologies, have also provided program users with avenues of maintaining their applications, such as downloading fixes and/or enhancements for the applications.

Today, developers often provide, as part of their applications, a user interface that enables users to administer the application. For example, Microsoft Exchange provides a series of user interfaces for performing functions such as adding and deleting users, changing their passwords and permissions, setting their storage size, etc. These interfaces are a component part of the application they service. Maintenance of the application, however, typically is not accomplished through a user interface that is a component of the application. Instead, developers tend to rely on user interfaces provided by the operating system, such as the Install Wizard of Microsoft's Windows, to facilitate users in maintaining the applications.

This customary approach, however, is subject to a number of disadvantages. First and foremost, it requires users to interact with and learn multiple user interfaces, some of which are component parts of the application, other of which are not. This increases the time it takes for users to accomplish the maintenance and administration of their applications.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of the present invention, in accordance with various embodiments;

FIGS. 2a-2h illustrate a series of embodiments where the one or more processes are email service provision processes and where the first user interface has a plurality of views organized into service providing modules of the first user interface, in accordance with various embodiments of the invention; and

FIG. 3 illustrates an example computer system suitable for use to practice the present invention, in accordance with various embodiments.

### DETAILED DESCRIPTION OF ILLUSTRATIVE EMBODIMENTS

Illustrative embodiments of the present invention include but are not limited to methods and apparatuses for facilitating a user in maintaining and administering one or more processes of an executing system image through a first user interface having a plurality of views. The one or more processes have a second user interface as well for administering the one or more processes, but the integration of administrative facilities into the first user interface makes recourse to this second interface substantially unnecessary.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(A B) or (B)”, that is “A” is optional.

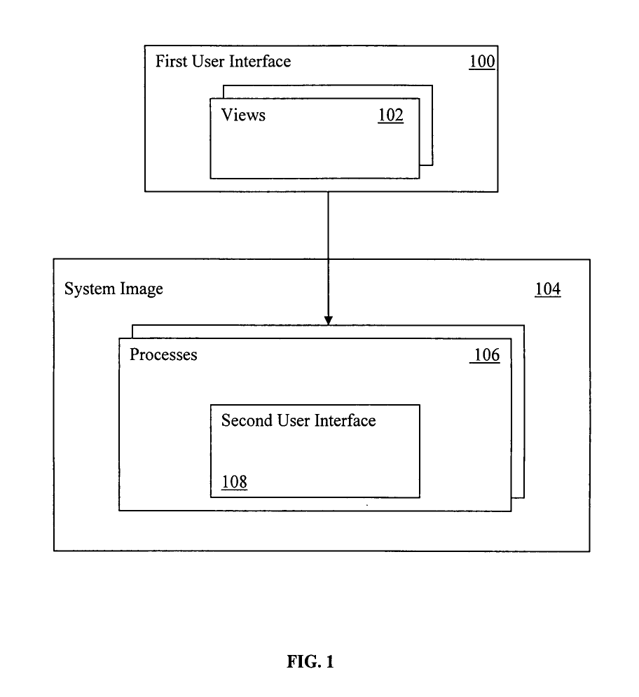

FIG. 1 illustrates an overview of the present invention, in accordance with various embodiments. As illustrated, system image 104 has one or more processes 106 executing in it. The one or more processes 106 may be any sort of processes. In some embodiments, the one or more processes 106 are email service provision processes, such as those offered by Microsoft Exchange Server.

Also, as illustrated, the one or more processes 106 of system image 104 have a first user interface 100 for administering and maintaining the one or more processes 106. The first user interface 100 may be a part of a separate computer system, such as a PC, and may even be located on an external network and communicate with the system image 104 and its executing one or more processes 106 via a networking fabric (not shown), such as a LAN, WAN, or the Internet. In alternate embodiments, however, both the first user interface 100 and the system image 104 may be implemented on the same computer system.

As shown, the first user interface 100 has a plurality of views 102, the plurality of views 102 having a common style, set of tools bars, and look and feel. To the user, the common elements of the plurality of views 102 cause the user to perceive the first user interface 100 to be one integrated interface.

In some embodiments, the one or more processes 106 also have a second user interface 108 that is a component part of the one or more processes 106. The second user interface 108 facilitates selected groups of users of the one or more processes 106 (such as authorized administrator users) in administering the one or more processes 106. An example of such a second user interface 108 of one or more processes 106 can be seen in Microsoft's Exchange Server. Exchange Server, in addition to providing email services, also provides certain authorized users with an interface for administering those services. The interface, which is a part of the Exchange Server application, allows users to add and delete other users, change their passwords, set storage quotas for mailboxes, and so forth.

The first user interface 100 of the present invention, however, does not need to be a component part of the one or more processes 106 in the way that the second user interface 108 may be. Rather, in various embodiments, the first user interface 100 may be external to the one or more processes 106, and may facilitate a user in both maintaining and administering the one or more processes 106. In fact, the first user interface 100, however, may facilitate administration of the one or more processes 106 so completely that recourse to the second user interface 108 is unnecessary.

Also, in various embodiments, first user interface 100 may be implemented as a web-based user interface usable through a browser. First user interface 100 need not be implemented as a web-based interface, however. First user interface 100 may be implemented as a separate application or as a process of a separate application, and may manifest itself as a graphical user interface or as a command line user interface.

Further, by facilitating the user in maintaining the one or more processes 106, the first user interface 100 may make recourse to some other external maintenance user interface, such as an install wizard, unnecessary. Thus, as presented and illustrated, a user may administer and maintain one or more processes 106 through the first user interface 100 without recourse to any other user interface, such as second user interface 108.

In various embodiments, the maintaining of the one or more processes 106 executing in the system image 104 is achieved at least in part by image-based maintenance. Image-based maintenance is the subject of co-pending U.S. patent application number Ser. No. ______, filed on Nov. 17, 2005, entitled “IMAGE-BASED SYSTEM MAINTENANCE,” and is described in greater detail there.

The image-based maintenance facilitated by the first user interface 100 consists at least in part of replacing the system image 104 with a localized (locally configured) received generic system image. The received generic system image has at least the same one or more processes 106 as system image 104, although the one or more processes 106 of the generic system image will have been updated with fixes, enhancements, or both. Upon receiving a generic system image, in some embodiments via a networking fabric such a LAN, a WAN, or the Internet, a user of the first user interface 100 may be notified of the receipt via one or more of the plurality of views 102, which may be organized into modules (as described in greater detail below). Should the user choose to maintain the one or more processes 106 by applying the generic system image, system image 104 will then reboot, and at reboot will apply localizing configuration data to the received generic system image. Upon completion of reboot, system image 104 will execute the one or more processes 106 with the one or more processes 106 having fixes, enhancements, or both.

Further, in various embodiments, the plurality of views 102 of the first user interface 100 may be organized into modules facilitating the administration and maintenance of the one or more processes 106. A module may contain one or more of the plurality of views 102 of the first user interface 100, a module being simply a collection of views directed toward facilitating specific types of operations, such as maintenance operations or administrative operations.

In a series of exemplary embodiments, where the one or more processes are email service provision processes such as the services of Microsoft Exchange Server, the modules may facilitate a number of administration and maintenance operations. A number of these services, described in greater detail below, include viewing and editing, by an authorized user, the authorized user's profile; providing user management, including facilitating an authorized user in adding and deleting other users, and in assigning roles to the other users; providing management of group memberships of an authorized user and of other users, including adding and deleting users; providing statistics about a number of email services, such as mailbox size and anti-virus scanning; providing operational status of the executing system image 104 having the email services and of various components of the system image 104, such as storage; providing email service policy management, including facilitating the user in setting such policies as a size of one or more other users' inboxes; allowing an authorized user to undo recent changes made by the authorized user or other users, and monitoring a log of recent changes; maintaining the email services of the executing system image 104 and monitoring the executing system image 104 to determine whether such maintenance is needed; monitoring and managing licenses for the processes on other components of the executing system image 104; and monitoring and managing the availability of remote storage, such as SAN, NAS, and DAS devices.

Continuing to describe the same series of exemplary embodiments, the views 102 and modules that a user of the first user interface 100 may access may depend on the user's assigned role. For example, a user might be assigned a role such as end user, user manager, or administrator, with each role enabling a user to interact with none, some, or all of the views 102 of the first user interface 100 (these roles are described in greater detail below). In various embodiments, only a user with the role of administrator may access views 102 of the first user interface 100 facilitating that user in maintaining the email services. First user interface 100 also facilitates a user in determining, based on the user's assigned role, which module-facilitated services are accessible to the user, that is, for which modules the user is an authorized user.

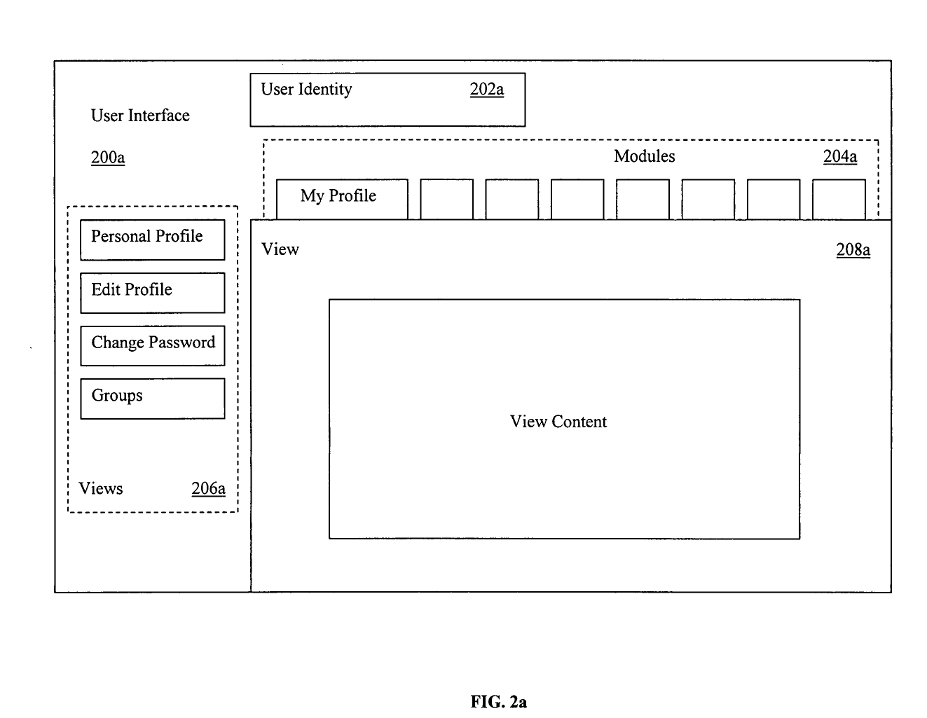

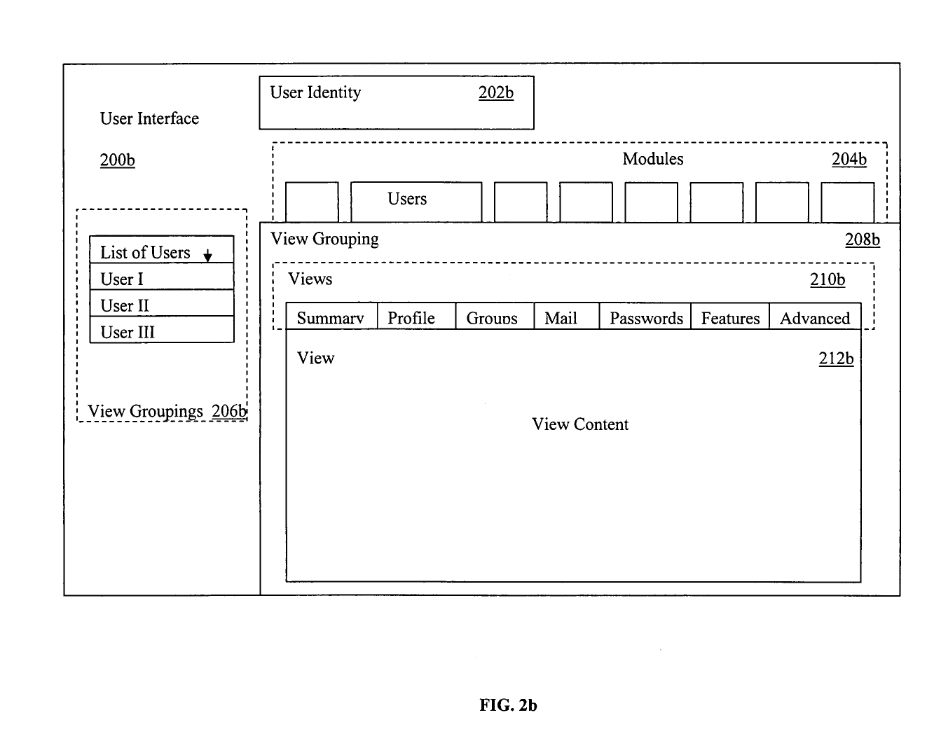

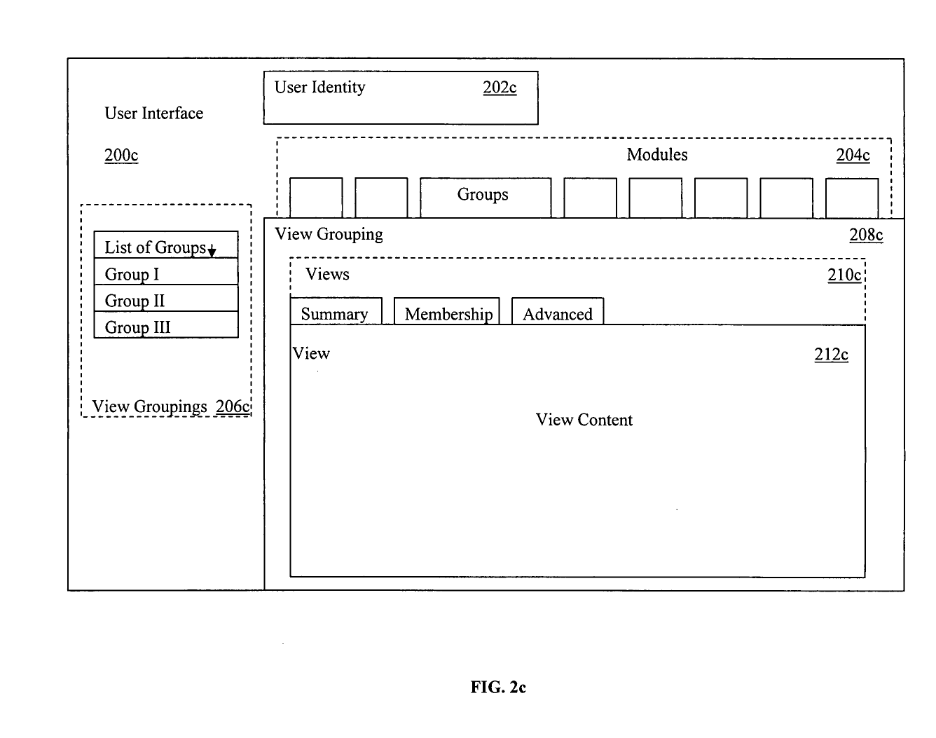

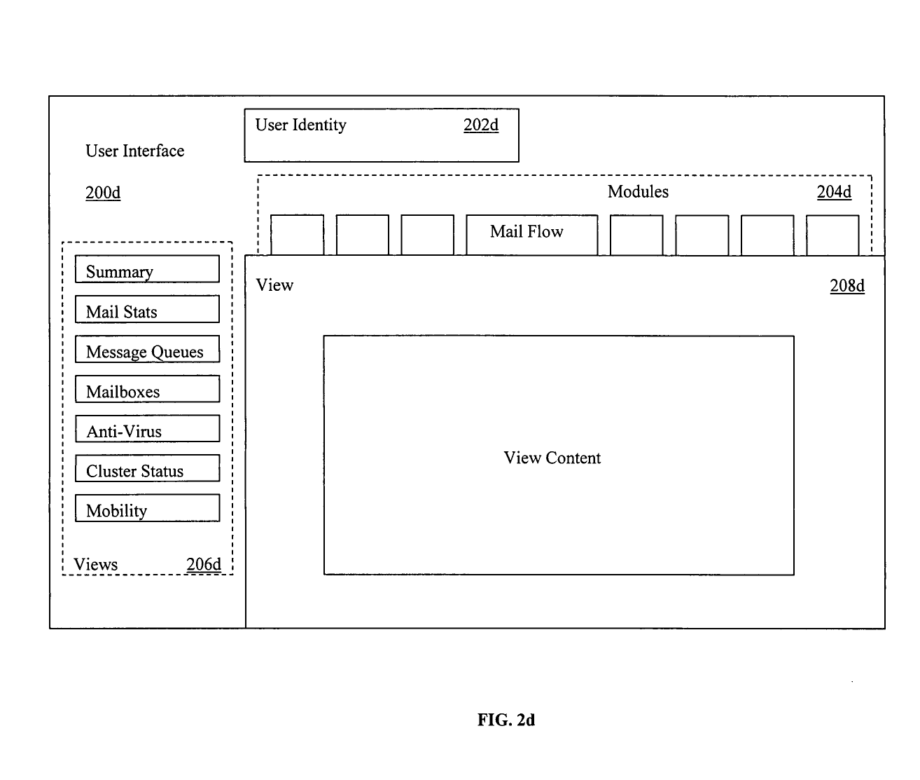

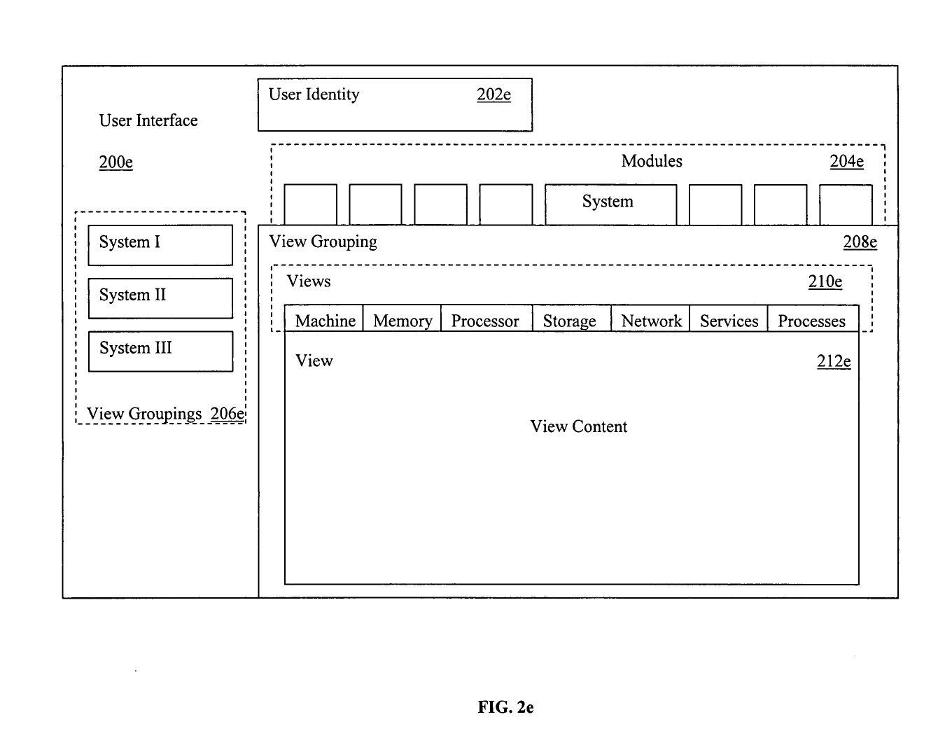

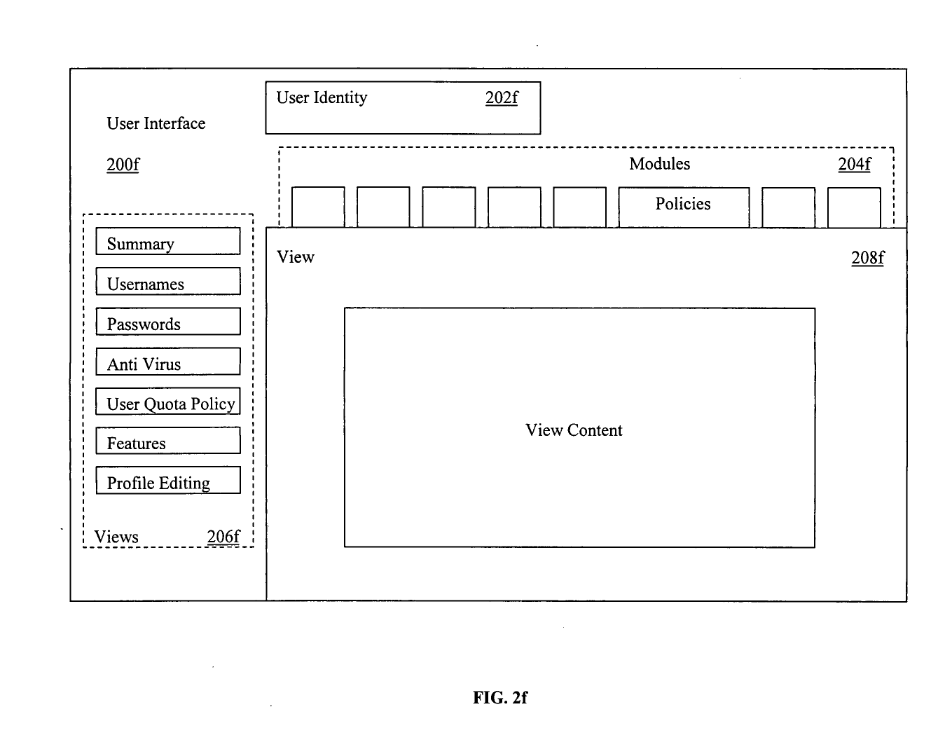

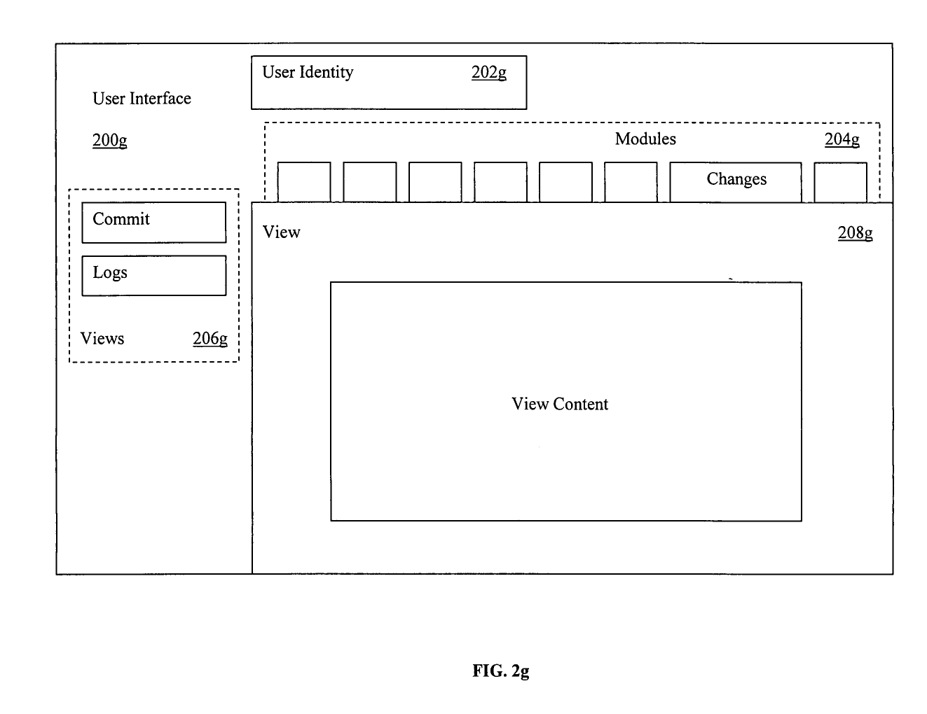

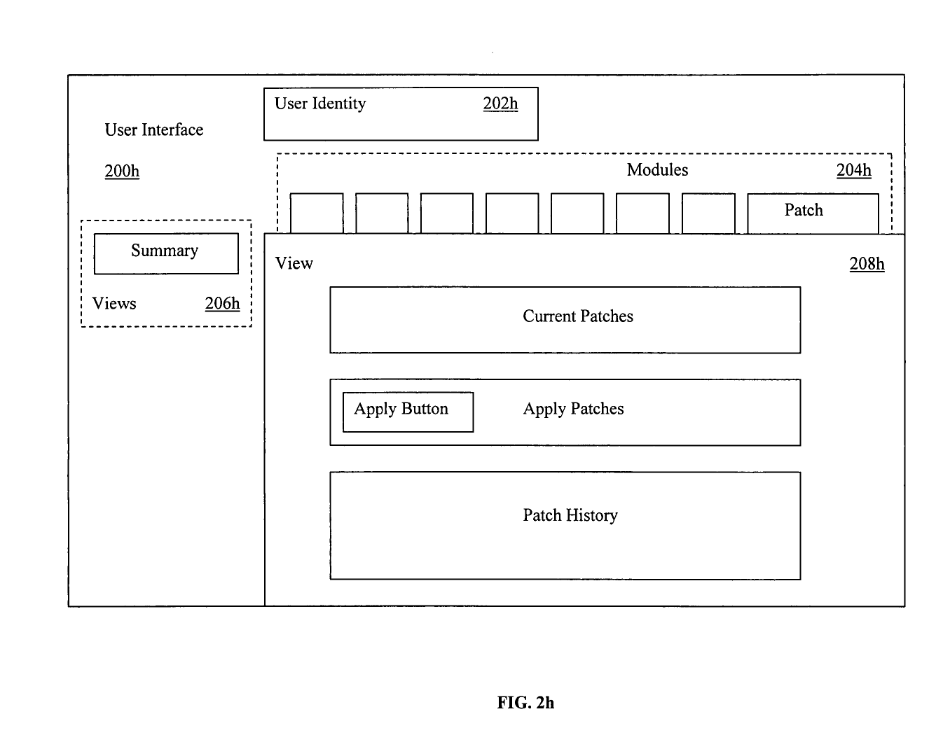

FIGS. 2a-2h illustrate a series of embodiments where the one or more processes 106 are email services and where the first user interface 100 has a plurality of views 102 organized into service providing modules of the first user interface 100, in accordance with various embodiments of the invention. The series of embodiments illustrated by FIGS. 2a-2h is by no means exhaustive. The first user interface 100 may facilitate processes 106 other than or in addition to email service provision processes, and need not have its views 102 organized into modules. Further, the modules illustrated and described herein are also by no means exhaustive. Any number of other email service facilitating modules might also be provisioned by the first user interface 100.

FIG. 2a illustrates a series of embodiments having a view 208a of a module 204a, the module 204a identified as “My Profile.” The view 208a is shown within an exemplary user interface 200a, exemplary user interface 200a operating in a manner identical to the above described first user interface 100. As illustrated in this series of embodiments, user interface 200a may provide the name and role of the user interacting with the user interface 200a as a user identity 202a, in this series of embodiments shown in the upper portion of the user interface 200a. By informing the user of his or her role, such as administrator, user manager, or end user, the user interface 200a may inform the user of the modules 204a and views 206a available to him or her.

Also, as illustrated in this series of embodiments, user interface 200a may list the available modules 204a as a series of tabs above the view 208a portion of the user interface 200a. By presenting modules 204a as tabs, the user is facilitated in quickly switching between modules 204a. Such modules may include, as illustrated in FIGS. 2a-2h, a module identified as “My Profile,” which facilitates viewing and editing, by the user, the user's profile; a module identified as “Users,” which facilitates providing user management, including facilitating an authorized administrator or user manager in adding and deleting other users, and in assigning roles to the other users; a module identified as “Groups,” which facilitates an authorized administrator user in providing management of group memberships of users, including adding and deleting users; a module identified as “Mail Flow,” which facilitates providing statistics about a number of email services, such as mailbox size and anti-virus scanning; a module identified as “System,” which facilitates providing operational status of the executing system image having the email services and of various components of the system image, such as storage; a module identified as “Policies,” which facilitates providing email service policy management, including facilitating an authorized administrator user in setting such policies as a size of one or more other users' inboxes; a module identified as “Changes,” which facilitates allowing an authorized administrator user to undo recent changes made by users, and monitoring a log of recent changes; and a module identified as “Patch,” which facilitates maintaining the email services of the executing system image and monitoring the executing system image to determine whether such maintenance is needed. The number of modules available to users through user interface 200a is in no way limited to the modules herein depicted. More, fewer, or different modules may be made available to users.

Once a module tab 204a is selected, as shown in this series of embodiments, available views for that module may be listed 206a, as shown, to the left of the view 208a portion of the user interface 200a. The list of views 206a may be presented as a series of buttons or links, that when interacted with by the user cause the view 208a associated with the listed view item to be displayed in view portion 208a.

As illustrated, module “My Profile” 204a has four views 206a: “Personal Profile,” “Edit Profile,” “Change Password,” and “Groups.”

The view 208a associated with the name “Personal Profile” (not shown) may display information about the user using the user interface 200a, such as the user's job title, address, phone numbers, and email.

The view 208a associated with the name “Edit Profile” (not shown) may allow the user to edit the information, or a subset of the information, displayed when the “Personal Profile” view 208a is selected.

The view 208a associated with the name “Change Password” (not shown) may allow the user to change the password he or she uses to access email services.

The view 208a associated with the name “Groups” (not shown) may allow the user to view groups the user is a member of, view groups the user is not a member of, and add one or more of those groups which the user is not a member of to the user's group membership list. A group, as referred to herein, may describe a list of email addresses to which some particular email content will be sent. The content may be security alerts, news items of interest, or any other content in which multiple users might have interest.

This illustrated list of views 206a and description of views 208a are provided to illustrate the sorts of services that a module 204a such as “My Profile” might facilitate. The depicted list and described views are by no means exhaustive, even within the context of this series of embodiments.

FIG. 2b illustrates a series of embodiments having a view 212b of a module 204b, the module 204b identified as “Users.” The view 212b is shown within an exemplary user interface 200b, exemplary user interface 200b operating in a manner identical to the above described first user interface 100. As illustrated in this series of embodiments, user interface 200b may provide the name and role of the user interacting with the user interface 200b as a user identity 202b, in this series of embodiments shown in the upper portion of the user interface 200b. By informing the user of his or her role, such as administrator, user manager, or end user, the user interface 200b may inform the user of the modules 204b and views 212b available to him or her.

Also, as illustrated in this series of embodiments, user interface 200b may list the available modules 204b as a series of tabs above the view 212b portion of the user interface 200b. By presenting modules as tabs, the user is facilitated in quickly switching between modules 204b. The enumeration and functionality of the exemplary modules depicted in FIGS. 2a-2h is described above. The number of modules available to users through user interface 200b is in no way limited to the modules herein depicted. More, fewer, or different modules may be made available to users.

Once the “Users” module tab 204b is selected, as shown in this series of embodiments, names of individual users (as shown in FIG. 2b, “User I,” “User II,” and “User III”) may be displayed as a list of users, each user representing a view grouping 208b. Thus, the list of users, constituting a list of view groupings 206b, may be shown to the left of the individual user view grouping 208b portion of the user interface 200b. The list of users 206b may be presented as a series of buttons or links, that when interacted with by the authorized user (here, an administrator or user manager) cause the view grouping 208b associated with that user to be displayed in view grouping portion 208b.

In this series of embodiments, once a user/view grouping 208b is selected, that user/view grouping may be displayed in the same portion of user interface 200b where views 208a of user interface 200a were displayed. Within the view grouping 208b portion of user interface 200b, a view 212b is displayed, the display of view 212b occupying most of the view grouping 208b portion of user interface 200b. Above the displayed view 212b, a list of available views 210b for that view grouping 208b may be displayed as a series of tabs.

As illustrated, a view grouping 208b has seven views 210b: “Summary,” “Profile,” “Groups,” “Mail,” “Passwords,” “Features,” and “Advanced.”

The view 212b associated with the name “Summary” (not shown) may display information about the selected user, such as the user's job title, address, phone numbers, and email.

The view 212b associated with the name “Profile” (not shown) may display pending changes the selected user has made to his or her profile using a view like the “Edit Profile” view 208a of the “My Profile” module 204a described above and depicted in FIG. 2a, and may facilitate an authorized user such as an administrator or user manager in the editing of information about the selected user.

The view 212b associated with the name “Groups” (not shown) may allow the authorized user, such as an administrator or user manager, to view groups the selected user is a member of, view groups the selected user is not a member of, and add one or more of those groups which the selected user is not a member of to the selected user's group membership list. The meaning of “group,” as used in this context, is discussed above.

The view 212b associated with the name “Mail” (not shown) may allow the authorized user, such as an administrator or user manager, to set mail forwarding, mailbox size, and message size defaults for the selected user.

The view 212b associated with the name “Passwords” (not shown) may allow the authorized user, such as an administrator or user manager, to set or change the password the selected user uses to access email services.

The view 212b associated with the name “Features” (not shown) may allow the authorized user, such as an administrator or user manager, to edit various features of the selected user's email services.

The view 212b associated with the name “Advanced” (not shown) may allow the authorized user, such as an administrator, to set the role of the selected user or delete the selected user. As described above, the role may be one of administrator, user manager, or end user. In some embodiments, user manager may be referred to as “Helpdesk.” Each role is associated with a number of views which it entitles users denominated with it to access. For instance, a user denominated with the role of administrator might be able to access each and every view 102 of every module of the first user interface 100; a user assigned the user manager/helpdesk role might be able to access the “Users” module and some or all of the views 102 associated with it, and the “My Profile” module and the views associated with it; and a user denominated with the role of end user might be able to access only the “My Profile” module and the views associated with it.

This illustrated list of views 210b and description of views 212b are provided to illustrate the sorts of services that a module 204b such as “Users” might facilitate. The depicted list and described views are by no means exhaustive, even within the context of this series of embodiments.

FIG. 2c illustrates a series of embodiments having a view 212c of a module 204c, the module 204c identified as “Groups.” The view 212c is shown within an exemplary user interface 200c, exemplary user interface 200c operating in a manner identical to the above described first user interface 100. As illustrated in this series of embodiments, user interface 200c may provide the name and role of the user interacting with the user interface 200c as a user identity 202c, in this series of embodiments shown in the upper portion of the user interface 200c. By informing the user of his or her role, such as administrator, user manager, or end user, the user interface 200c may inform the user of the modules 204c and views 212c available to him or her.

Also, as illustrated in this series of embodiments, user interface 200c may list the available modules 204c as a series of tabs above the view 212c portion of the user interface 200c. By presenting modules 204c as tabs, the user is facilitated in quickly switching between modules 204c. The enumeration and functionality of the exemplary modules depicted in FIGS. 2a-2h is described above. The number of modules available to users through user interface 200c is in no way limited to the modules herein depicted. More, fewer, or different modules may be made available to users.

Once the “Groups” module tab 204c is selected, as shown in this series of embodiments, names of individual groups (as shown in FIG. 2c, “Group I,” “Group II,” and “Group III”) may be displayed as a list of groups, each group representing a view grouping 208c. Thus, the list of groups, constituting a list of view groupings 206c, may be shown to the left of the view grouping 208c portion of the user interface 200c. The list of groups 206c may be presented as a series of buttons or links, that when interacted with by the user (here, an administrator) cause the view grouping 208c associated with that group to be displayed in view grouping portion 208c.

In this series of embodiments, once a group/view grouping 208c is selected, that group/view grouping 208c may be displayed in the same portion of user interface 200c where views 208a of user interface 200a were displayed. Within the view grouping 208c portion of user interface 200c, a view 212c is displayed, the display of view 212c occupying most of the view grouping 208c portion of user interface 200c. Above the displayed view, a list of available views 210c for that view grouping 208c may be displayed as a series of tabs.

As illustrated, a view grouping 208c has three views 210c: “Summary,” “Membership,” and “Advanced.”

The view 212c associated with the name “Summary” (not shown) may display information about a group, such as its name and an alias. The meaning of “group,” as used in this context, is discussed above.

The view 212c associated with the name “Membership” (not shown) may allow the authorized user, such as an administrator, to view users that are members of the selected group, view users that are not members of the selected group, and add one or more of the non-member users to the selected group's membership list.

The view 212c associated with the name “Advanced” (not shown) may allow the authorized user, such as an administrator, to delete the selected group from the list of groups 206c.

This illustrated list of views 210c and description of views 212c are provided to illustrate the sorts of services that a module 204c such as “Groups” might facilitate. The depicted list and described views are by no means exhaustive, even within the context of this series of embodiments.

FIG. 2d illustrates a series of embodiments having a view 208d of a module 204d, the module 204d identified as “Mail Flow.” The view 208d is shown within an exemplary user interface 200d, exemplary user interface 200d operating in a manner identical to the above described first user interface 100. As illustrated in this series of embodiments, user interface 200d may provide the name and role of the user interacting with the user interface 200d as a user identity 202d, in this series of embodiments shown in the upper portion of the user interface 200d. By informing the user of his or her role, such as administrator, user manager, or end user, the user interface 200d may inform the user of the modules 204d and views 206d available to him or her.

Also, as illustrated in this series of embodiments, user interface 200d may list the available modules 204d as a series of tabs above the view 208d portion of the user interface 200d. By presenting modules as tabs, the user is facilitated in quickly switching between modules 204d. The enumeration and functionality of the exemplary modules depicted in FIGS. 2a-2h is described above. The number of modules available to users through user interface 200d is in no way limited to the modules herein depicted. More, fewer, or different modules may be made available to users.

Once a module tab 204d is selected, as shown in this series of embodiments, available views for that module 204d may be listed 206d, as shown, to the left of the view 208d portion of the user interface 200d. The list of views 206d may be presented as a series of buttons or links, that when interacted with by the user (here, an administrator) cause the view 208d associated with the listed view item to be displayed in view portion 208d.

As illustrated, module “Mail Flow” 204d has seven views 206d: “Summary,” “Mail Stats,” “Message Queues,” “Mailboxes,” “Anti-Virus,” “Cluster Status,” and “Mobility.”

The view 208d associated with the name “Summary” (not shown) may allow the authorized user, such as an administrator, to access a summary of all mail flow statistics of the system.

The view 208d associated with the name “Mail Stats” (not shown) may allow the authorized user, such as an administrator, to view statistics describing the email service such as the number of messages sent by the service, the amount of memory occupied by the email service, and other related statistics.

The view 208d associated with the name “Message Queues” (not shown) may allow the authorized user, such as an administrator, to view the number of messages queued over a given period of time.

The view 208d associated with the name “Mailboxes” (not shown) may allow the authorized user, such as an administrator, to view the size and number of items each user has in his or her mailbox.

The view 208d associated with the name “Anti-Virus” (not shown) may allow the authorized user, such as an administrator, to view the number of message scanned for viruses, the number of messages found to contain viruses, and the number of infected messages that have been deleted.

The view 208d associated with the name “Cluster Status” (not shown) may allow the authorized user, such as an administrator, to view email service resources, such as storage disks and IP addresses that are available for use by the email service.

The view 208d associated with the name “Mobility” (not shown) may allow the authorized user, such as an administrator, to view the number of messages sent to the mobile server, the mobile server allowing users to access their email on remote devices such as cell phones and PDAs.

This illustrated list of views 206d and description of views 208d are provided to illustrate the sorts of services that a module 204d such as “Mail Flow” might facilitate. The depicted list and described views are by no means exhaustive, even within the context of this series of embodiments.

FIG. 2e illustrates a series of embodiments having a view 212e of a module 204e, the module 204e identified as “System.” The view 212e is shown within an exemplary user interface 200e, exemplary user interface 200e operating in a manner identical to the above described first user interface 100. As illustrated in this series of embodiments, user interface 200e may provide the name and role of the user interacting with the user interface 200e as a user identity 202e, in this series of embodiments shown in the upper portion of the user interface 200e. By informing the user of his or her role, such as administrator, user manager, or end user, the user interface 200e may inform the user of the modules 204e and views 212e available to him or her.

Also, as illustrated in this series of embodiments, user interface 200e may list the available modules 204e as a series of tabs above the view 212e portion of the user interface 200e. By presenting modules as tabs, the user is facilitated in quickly switching between modules 204e. The enumeration and functionality of the exemplary modules depicted in FIGS. 2a-2h is described above. The number of modules available to users through user interface 200e is in no way limited to the modules herein depicted. More, fewer, or different modules may be made available to users.

Once the “System” module tab 204e is selected, as shown in this series of embodiments, names of systems (as shown in FIG. 2e, “System I,” “System II,” and “System III”) may be displayed as a list of systems 206e, each system representing a view grouping 208e. “System,” as used in this context, may refer to an executing system image like system image 100. Thus, as illustrated in this series of embodiments, user interface 200e may monitor multiple executing system images.

The list of systems, then, constituting a list of view groupings 206e, may be shown to the left of the system view grouping 208e portion of the user interface 200e. The list of systems 206e may be presented as a series of buttons or links, that when interacted with by the user (here, an administrator) cause the view grouping 208e associated with that system to be displayed in view grouping portion 208e.

In this series of embodiments, once a system/view grouping 208e is selected, that system/view grouping 208e may be displayed in the same portion of user interface 200e where views 208a of user interface 200a were displayed. Within the view grouping 208e portion of user interface 200e, a view 212e is displayed, the display of view 212e occupying most of the view grouping 208e portion of user interface 200e. Above the displayed view 212e, a list of available views 210e for that view grouping 208e may be displayed as a series of tabs.

As illustrated, a view grouping 208e has seven views 210b: “Machine,” “Memory,” “Processor,” “Storage,” “Network,” “Services,” and “Processes.”

The view 212e associated with the name “Machine” (not shown) may display information about the selected system, such as the size of its system memory, the type of its operating system, the time of its last reboot, and its serial number.

The view 212e associated with the name “Memory” (not shown) may display the amount of available system memory used over a period of time.

The view 212e associated with the name “Processor” (not shown) may display selected system processor usage over a given period of time.

The view 212e associated with the name “Storage” (not shown) may display a list of the amounts of storage devices or partitions of storage devices that are used.

The view 212e associated with the name “Network” (not shown) may display the amount of packets sent and received over a number of network adapters over a given period of time.

The view 212e associated with the name “Services” (not shown) may display a list of the services running on the system as well as the status of those services.

The view 212e associated with the name “Processes” (not shown) may display a list of the processes executing on the selected system as well as the amount of system memory each process is utilizing.

This illustrated list of views 210e and description of views 212e are provided to illustrate the sorts of services that a module 204e such as “System” might facilitate. The depicted list and described views are by no means exhaustive, even within the context of this series of embodiments.

FIG. 2f illustrates a series of embodiments having a view 208f of a module 204f, the module 204f identified as “Policies.” The view 208f is shown within an exemplary user interface 200f, exemplary user interface 200f operating in a manner identical to the above described first user interface 100. As illustrated in this series of embodiments, user interface 200f may provide the name and role of the user interacting with the user interface 200f as a user identity 202f, in this series of embodiments shown in the upper portion of the user interface 200f. By informing the user of his or her role, such as administrator, user manager, or end user, the user interface 200f may inform the user of the modules 204f and views 206f available to him or her.

Also, as illustrated in this series of embodiments, user interface 200f may list the available modules 204f as a series of tabs above the view 208f portion of the user interface 200f. By presenting modules as tabs, the user is facilitated in quickly switching between modules 204f. The enumeration and functionality of the exemplary modules depicted in FIGS. 2a-2h is described above. The number of modules available to users through user interface 200f is in no way limited to the modules herein depicted. More, less, or different modules may be made available to users.

Once a module tab 204f is selected, as shown in this series of embodiments, available views for that module 204f may be listed 206f, as shown, to the left of the view 208f portion of the user interface 200f. The list of views 206f may be presented as a series of buttons or links, that when interacted with by the user (here, an administrator) cause the view 208f associated with the listed view item to be displayed in view portion 208f.

As illustrated, module “Policies” 204f has seven views 206f: “Summary,” “Usernames,” “Passwords,” “Anti Virus,” “User Quota Policy,” “Features,” and “Profile Editing.”

The view 208f associated with the name “Summary” (not shown) may allow the authorized user, such as an administrator, to access a summary of all requirements relating to user profiles, such as the length of the user name, required number of letters and numbers for a password, and which properties users may edit while accessing their profiles in the manner illustrated and described above under FIG. 2a.

The view 208f associated with the name “Usernames” (not shown) may allow the authorized user, such as an administrator, to set policies regarding the formatting of usernames, such as length and portions of the name required (i.e., middle initial, etc.).

The view 208f associated with the name “Passwords” (not shown) may allow the authorized user, such as an administrator, to set policies regarding the requirements of passwords, such as the minimum length in characters, whether both upper case and lower case characters are required, and whether numbers are required.

The view 208f associated with the name “Anti Virus” (not shown) may allow the authorized user, such as an administrator, to set the anti-virus scanning requirements for user email services, such as whether scans are required for each incoming message.

The view 208f associated with the name “User Quota Policy” (not shown) may allow the authorized user, such as an administrator, to set the maximum storage size for user inboxes, as well as a threshold at which users will be warned.

The view 208f associated with the name “Features” (not shown) may allow the authorized user, such as an administrator, to set policies regarding the use of email service features by users.

The view 208f associated with the name “Profile Editing” (not shown) may allow the authorized user, such as an administrator, to set policies regarding which properties users may edit while accessing their profiles in the manner illustrated and described above under FIG. 2a.

This illustrated list of views 206f and description of views 208f are provided to illustrate the sorts of services that a module 204f such as “Policies” might facilitate. The depicted list and described views are by no means exhaustive, even within the context of this series of embodiments.

FIG. 2g illustrates a series of embodiments having a view 208g of a module 204g, the module 204g identified as “Changes.” The view 208g is shown within an exemplary user interface 200g, exemplary user interface 200g operating in a manner identical to the above described first user interface 100. As illustrated in this series of embodiments, user interface 200g may provide the name and role of the user interacting with the user interface 200g as a user identity 202g, in this series of embodiments shown in the upper portion of the user interface 200g. By informing the user of his or her role, such as administrator, user manager, or end user, the user interface 200g may inform the user of the modules 204g and views 206g available to him or her.

Also, as illustrated in this series of embodiments, user interface 200g may list the available modules 204g as a series of tabs above the view 208g portion of the user interface 200g. By presenting modules 204g as tabs, the user is facilitated in quickly switching between modules 204g. The enumeration and functionality of the exemplary modules depicted in FIGS. 2a-2h is described above. The number of modules available to users through user interface 200g is in no way limited to the modules herein depicted. More, fewer, or different modules may be made available to users.

Once a module tab 204g is selected, as shown in this series of embodiments, available views for that module 204g may be listed 206g, as shown, to the left of the view 208g portion of the user interface 200g. The list of views 206g may be presented as a series of buttons or links, that when interacted with by the user (here, an administrator) cause the view 208g associated with the listed view item to be displayed in view portion 208g.

As illustrated, module “Changes” 204g has two views 206g: “Commit,” and “Logs.”

The view 208g associated with the name “Commit” (not shown) may allow the authorized user, such as an administrator, to accept or reject a change or changes made by one or more users to the users' profiles.

The view 208g associated with the name “Logs” (not shown) may allow the authorized user, such as an administrator, to view a list of the most recent changes made to user profiles by users and whether or not those changes have been accepted.

This illustrated list of views 206g and description of views 208g are provided to illustrate the sorts of services that a module 204g such as “Changes” might facilitate. The depicted list and described views are by no means exhaustive, even within the context of this series of embodiments.

FIG. 2h illustrates a series of embodiments having a view 208h of a module 204h, the module 204h identified as “Patch.” The view 208h is shown within an exemplary user interface 200h, exemplary user interface 200h operating in a manner identical to the above described first user interface 100. As illustrated in this series of embodiments, user interface 200h may provide the name and role of the user interacting with the user interface 200h as a user identity 202h, in this series of embodiments shown in the upper portion of the user interface 200h. By informing the user of his or her role, such as administrator, user manager, or end user, the user interface 200h may inform the user of the modules 204h and views 206h available to him or her.

Also, as illustrated in this series of embodiments, user interface 200h may list the available modules 204h as a series of tabs above the view 208h portion of the user interface 200h. By presenting modules 204h as tabs, the user is facilitated in quickly switching between modules 204h. The enumeration and functionality of the exemplary modules depicted in FIGS. 2a-2h is described above. The number of modules available to users through user interface 200h is in no way limited to the modules herein depicted. More, fewer, or different modules may be made available to users.

Once a module tab 204h is selected, as shown in this series of embodiments, available views for that module 204h may be listed 206h, as shown, to the left of the view 208h portion of the user interface 200h. The list of views 206h may be presented as a series of buttons or links, that when interacted with by the user (here, an administrator) cause the view 208h associated with the listed view item to be displayed in view portion 208h.

As illustrated, module “Patch” 204h has one view 206h: “Summary.”

The view 208h associated with the name “Summary” may allow the authorized user, such as an administrator, to view the current version of the process and latest applied fixes and/or enhancements for the one or more processes 106 of the system image 100, to apply a received fix and/or enhancement, and to view the history of previously applied fixes and/or enhancements. As shown, the authorized user may maintain the process through the user interface 200h by interacting with the “Apply Button” key of view 208h. Such interaction may cause the fix and/or enhancement to be applied in the image-based maintenance process described above.

This illustrated list of views 206h and description of views 208h are provided to illustrate the sorts of services that a module 204h such as “Patch” might facilitate. The depicted list and described views are by no means exhaustive, even within the context of this series of embodiments.

Additional modules facilitating other services, not illustrated, may include a license management module and a remote storage management module.

A license management module, not illustrated, may facilitate an authorized user, such as an administrator, through one or more of its views, in monitoring usage of system image 104 components and allocated licenses. The module may also facilitate the user in adding and suspending licenses, and may in some way indicate to the authorized user when additional licenses for a system image component may be needed. In some embodiments, this indication might take the form of color coding each component based on the percentage of available licenses being used. For example, if all licenses are being used, the component may be color coded in red, indicating to the authorized user that additional component licenses may be needed. Similarly, if few licenses are being used, the component may be color coded in green, indicating to the authorized user that additional component licenses are not needed. Also, if many licenses are being used, the component may be color coded in yellow, indicating to the authorized user that additional component licenses may be needed.

A remote storage management module, not illustrated, may facilitate an authorized user, such as an administrator, through one or more of its views, in monitoring connected SAN, NAS, and DAS remote storage devices to determine storage usage and forecast future storage needs.

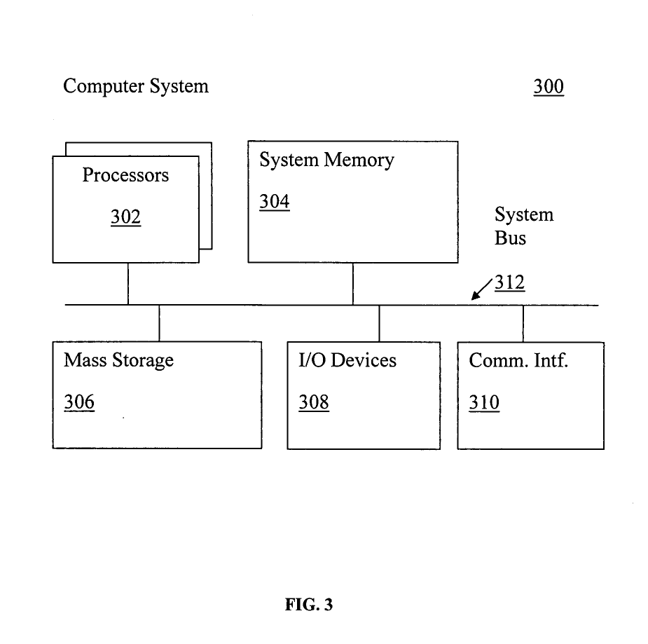

FIG. 3 illustrates an example computer system suitable for use to practice the client and/or server aspect of the present invention, in accordance with various embodiments. As shown, computer system 300 includes one or more processors 302 and system memory 304. Additionally, computer system 300 includes input/output devices 308 (such as keyboard, cursor control, and so forth). The elements are coupled to each other via system bus 312, which represents one or more buses. In the case of multiple buses, they are bridged by one or more bus bridges (not shown). Each of these elements performs its conventional functions known in the art. In particular, system memory 304 and mass storage 306 are employed to store working copies of the first user interface and/or the system image and permanent copies of the programming instructions implementing the first user interface and/or the system image, respectively. The permanent copies of the instructions implementing the first user interface and/or the system image may be loaded into mass storage 306 in the factory, or in the field, through a distribution medium (not shown) or through communication interface 310 (from a distribution server, not shown). The constitution of these elements 302-312 is known, and accordingly will not be further described.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. This application is intended to cover any adaptations or variations of the embodiments discussed herein. Therefore, it is manifestly intended that this invention be limited only by the claims and the equivalents thereof.

What is claimed is:

1. A method comprising:
facilitating a user in maintaining one or more processes executing in a system image through a first user interface having a plurality of views, the one or more processes having a second user interface for administering usage of the one or more processes; and
additionally facilitating the user in administering usage of the one or more processes through the first user interface.

2. The method of claim 1, wherein both of said facilitating comprise facilitating with the first user interface being a web-based user interface.

3. The method of claim 1, wherein said facilitating of a user in maintaining comprises facilitating a user in maintaining the one or more processes executing in the system image via an image-based maintenance approach.

4. The method of claim 3, wherein said facilitating of a user in maintaining the one or more processes via an image-based approach comprises facilitating local configuring of a generic system image having the one or more processes with fixes, enhancements, or both already applied, and replacing the executing system image with said locally configured system image.

5. The method of claim 1, wherein the one or more processes are email service provision processes.

6. The method of claim 5, wherein both of said facilitating comprises facilitating a plurality of views of the first user interface organized into modules.

7. The method of claim 6, wherein said facilitating of a plurality of views of the first user interface organized into modules comprises facilitating a plurality of views of the first user interface organized into at least two modules selected from the module group consisting of a module adapted for viewing and editing, by an authorized user, the authorized user's profile;
a module adapted for providing user management, including facilitating an authorized user in adding and deleting other users, and in assigning roles to the other users;
a module adapted for providing management of group memberships of an authorized user and of other users, including adding and deleting users;
a module adapted for providing statistics about a number of email services;
a module adapted for providing operational status of the executing system image;
a module adapted for providing email service policy management;
a module adapted for allowing an authorized user to undo recent changes made by the authorized user or other users and for monitoring a log of recent changes;
a module adapted for maintaining the email services of the executing system image and for monitoring the executing system image to determine whether maintenance is needed;
a module adapted for monitoring and managing licenses for the processes and other components of the executing system image; and
a module adapted for monitoring and managing availability of remote storage.

8. The method of claim 7, wherein the at least two modules include the module adapted for providing user management, including facilitating an authorized user in adding and deleting other users, and in assigning roles to the other users, where the user role assigned may be one of the group consisting of an end user role, a user managing role, and an administrator role.

9. The method of claim 7, wherein the at least two modules include the module adapted for providing user management, including facilitating an authorized user in adding and deleting other users, and in assigning roles to the other users, and the method further comprises facilitating a user in determining, based at least in part on an assigned role, which module-facilitated services are accessible to the user.

10. An apparatus comprising:
first one or more modules adapted to facilitate a user in maintaining one or more processes executing in a system image through a first user interface having a plurality of views, the one or more processes having a second user interface for administering the one or more processes; and
second one or more modules adapted to facilitate the user in administering the one or more processes through the first user interface.

11. The apparatus of claim 10, wherein the system image is on another computer system different from the apparatus.

12. The apparatus of claim 10, wherein the apparatus further includes a processor, the processor operating at least the first or the second one or more modules.

13. The apparatus as set forth in claim 12, where both the first and the second one or more modules are operated by the processor, and the apparatus further includes a storage medium storing first and second pluralities of programming instructions correspondingly implementing the first and the second one or more modules.

14. The apparatus of claim 10, wherein the first user interface is a web-based user interface.

15. The apparatus of claim 10, wherein the one or more processes executing in the system image are maintained at least in part via an image-based maintenance approach.

16. The apparatus of claim 15, wherein the image-based maintenance approach comprises local configuring of a generic system image having the one or more processes with fixes, enhancements, or both, already applied, and replacing the executing system image with said locally configured system image.

17. The apparatus of claim 10, wherein the one or more processes are email service provision processes.

18. The apparatus of claim 17, wherein the plurality of views of the first user interface are organized into modules.

19. The apparatus of claim 18, wherein the plurality of views are organized into at least two modules, the at least two modules selected from the module group consisting of
a module adapted for viewing and editing, by an authorized user, the authorized user's profile;
a module adapted for providing user management, including facilitating an authorized user in adding and deleting other users, and in assigning roles to the other users;
a module adapted for providing management of group memberships of an authorized user and of other users, including adding and deleting users;
a module adapted for providing statistics about a number of email services;
a module adapted for providing operational status of the executing system image;
a module adapted for providing email service policy management;
a module adapted for allowing an authorized user to undo recent changes made by the authorized user or other users and for monitoring a log of recent changes;
a module adapted for maintaining the email services of the executing system image and for monitoring the executing system image to determine whether maintenance is needed;
a module adapted for monitoring and managing licenses for the processes and other components of the executing system image; and
a module adapted for monitoring and managing availability of remote storage.

20. The apparatus of claim 19, wherein the at least two modules include the module adapted for providing user management, including facilitating an authorized user in adding and deleting other users, and in assigning roles to the other users, where the user role assigned may be one of the group consisting of an end user role, a user managing role, and an administrator role.

21. The apparatus of claim 19, wherein the at least two modules include the module adapted for providing user management, including facilitating an authorized user in adding and deleting other users, and in assigning roles to the other users, and the method further comprises facilitating a user in determining, based at least in part on an assigned role, which module-facilitated services are accessible to the user.

22. An article of manufacture comprising:
a storage medium having stored therein a plurality of programming instructions designed to program an apparatus, which when executed enable the apparatus to
facilitate a user in maintaining one or more processes executing in a system image through a first user interface having a plurality of views, the one or more processes having a second user interface for administering the one or more processes; and
facilitate the user in administering the one or more processes through the first user interface.

23. The article of manufacture of claim 22, wherein the system image is on another computer system different from the apparatus.

24. The article of manufacture of claim 22, wherein the first user interface is a web-based user interface.

25. The article of manufacture of claim 22, wherein the one or more processes executing in the system image are maintained at least in part via an image-based maintenance approach.

26. The article of manufacture of claim 25, wherein the image-based maintenance approach comprises local configuring of a generic system image having the one or more processes with fixes, enhancements, or both, already applied, and replacing the executing system image with said locally configured system image.

27. The article of manufacture of claim 22, wherein the one or more processes are email service provision processes.

28. The article of manufacture of claim 27, wherein the plurality of views of the first user interface are organized into modules.

29. The article of manufacture of claim 28, wherein the plurality of views are organized into at least two modules, the at least two modules selected from the module group consisting of a module adapted for viewing and editing, by an authorized user, the authorized user's profile;
a module adapted for providing user management, including facilitating an authorized user in adding and deleting other users, and in assigning roles to the other users;
a module adapted for providing management of group memberships of an authorized user and of other users, including adding and deleting users;
a module adapted for providing statistics about a number of email services;
a module adapted for providing operational status of the executing system image;
a module adapted for providing email service policy management;
a module adapted for allowing an authorized user to undo recent changes made by the authorized user or other users and for monitoring a log of recent changes;
a module adapted for maintaining the email services of the executing system image and for monitoring the executing system image to determine whether maintenance is needed;
a module adapted for monitoring and managing licenses for the processes and other components of the executing system image; and
a module adapted for monitoring and managing availability of remote storage.

30. The article of manufacture of claim 29, wherein the at least two modules include the module adapted for providing user management, including facilitating an authorized user in adding and deleting other users, and in assigning roles to the other users, where the user role assigned may be one of the group consisting of an end user role, a user managing role, and an administrator role.

31. The article of manufacture of claim 29, wherein the at least two modules include the module adapted for providing user management, including facilitating an authorized user in adding and deleting other users, and in assigning roles to the other users, and the method further comprises facilitating a user in determining, based at least in part on an assigned role, which module-facilitated services are accessible to the user.
